(19) United States
(12) Patent Application Publication
(10) Pub. No.: US 2010/0283798 A1
(43) Pub. Date: Nov. 11, 2010

(54) PRESENTATION SYSTEM

(76) Inventors: Mark Hallbauer, Dresden (DE); Holm Hallbauer, Dresden (DE)

Correspondence Address: MICHAEL BEST & FRIEDRICH LLP, 100 E WISCONSIN AVENUE, Suite 3300, MILWAUKEE, WI, 53202, US

(21) Appl. No.: 12/664,239

(22) PCT Filed: Apr. 1, 2008
(86) PCT No.: PCT/EP08/02598

§ 371 Date: May 14, 2010

(30) Foreign Application Priority Data
Jun. 14, 2007 (DE) 10 2007 028 011.6
Sep. 19, 2007 (EP) 07018430.4
Sep. 19, 2007 (EP) 07018431.2

(51) Int. Cl. G09G 5/00; G06F 1/16

(52) U.S. Cl. 345/659; 361/679.21; 361/679.06; 361/679.08

(57) ABSTRACT

The invention relates to a novel presentation system (1) allowing particularly flexible use thereof, which comprises the following: an operating module (10) having an associated operating module monitor (11) for depicting first informational content and for depicting data for controlling a presentation flow depicted on a base module monitor (21); an input interface (12), which is coupled to the operating module (10) and via which data can be input; a base module (20), which is or can he electrically connected to the operating module (10), having a base module monitor (21) for depicting second informational content; a control module (40), which is configured to control the operating module monitor (11) and the base module monitor (21) individually, as a function of a presentation loaded in the presentation system (1) and/or of the data input via the input interface (12); and a cover (30), which can be pivoted relative to the base module (20) about a first axis of rotation (23) and which is connected to the base module (20), and which interacts with the base module (20) such that the presentation system (1) is swiveled from a first state, in which the cover (30) with the inside (31) of the main surface (32) thereof rests at least partially on the base module monitor (21), into a second state, in which the cover (30) is pivoted about the first axis of rotation (21) relative to the base module (20), and the base module monitor (21) points in a first direction, and can be transferred into a third state, in which the base module monitor (21) points in a second direction, which is opposite the first direction.

The present invention relates to a presentation system, especially for use as an electronic selling aid for advertisements, for example in print media, or for insurance policies, the presentation system having a base module having a base module monitor for showing a presentation intended for a customer and a control module for controlling the base module having the base module monitor in dependence on commands and/or data input into the presentation system. The presentation system further has a cover connected to the base module for situation-specific orientation of the base module during a customer discussion.

When making sales proposals for services and goods, especially proposals for advertisements in print media, on the internet or the like, or proposals for insurance policies etc., it is necessary for the service-provider or salesperson to present his proposal to the customer in question in an, as far as possible, optimally adapted form. In a presentation of such a kind, it is frequently desirable not just to convince the (potential) customer about a proposal but also to find a solution that is, as far as possible, optimised for the customer. For this purpose it is usually necessary that the solution is not drawn up in its definitive form until during the discussion with the customer. This efficiently ensures that, in the end, a tailor-made proposal can be submitted to the customer.

However, when drawing up a customer-specific solution during the discussion with the customer, it has to be ensured that, on the one hand, the customer data required by the service-provider or salesperson is available in transparent form to the service-provider and customer and that, on the other hand, a proposal that is specific to the customer is drawn up in a manner that is clear and that can be followed by the customer. It is frequently necessary during such a customer discussion first to convince the customer of the fact that, for example, a service being newly offered does indeed hold promise of economic success.

On the other hand, it has to be considered that, in the customer discussion, the salesperson or service-provider will have only a limited time available in each case in order to impart his concept to the customer. It is accordingly necessary for this concept to be put across to the customer in an, as far as possible, optimum manner in a short time.

In order to be able to specifically adapt a service to a particular customer, customer-specific data such as, for example, the level of sales of the customer, the market share of the customer, the number of employees of the customer etc. is required. This information is usually available, in the form of card-index cards, to the salesperson before the customer discussion. However, it is often not certain, as far as the salesperson is concerned, that this data is up to date. Therefore, at the start of each sales discussion, the data of the customer is usually discussed with the customer. In order for there to be transparency between the salesperson and the customer, it would then be necessary, for example, for the customer data to be presented on a printed-out sheet of paper.

It is furthermore necessary, at the start of the discussion, to briefly inform the customer about the advantages of the service or goods being offered by the salesperson. For this purpose, hand-outs or similar information sheets are customarily used, which are presented and subsequently handed to the customer. Often in a discussion with a customer the salesperson furthermore presents a proposal (already more or less adapted to the customer), in which the service proposed by the salesperson has already been incorporated. Such a proposal is often also prepared by the salesperson in the form of a hand-out and is handed to the customer during the customer discussion. On the basis of such a proposal, the actual customer-matched solution is usually then jointly drawn up during the sales discussion.

Accordingly, several different hand-outs are usually used as selling aids, in which the advantages of the service offered or of the goods offered are presented during a sales discussion. Moreover, a further additional hand-out is frequently used, by means of which a proposal is submitted to the customer, already incorporating the offered service or goods. Furthermore there is often provided a third hand-out, in which the actual customer-specific solution is drawn up together with the customer during the customer discussion. In all, therefore, a large number of hand-outs, information sheets etc. have hitherto been necessary, which the salesperson and the customer have to discuss during such a sales discussion.

The disadvantage of that customary solution is to be seen especially in the fact that, in the course of the sales discussion, the customer or client frequently loses their overview of the usefulness and advantageousness of the offered service or goods. This means, in other words, that the salesperson can no longer effectively present his service or goods. Likewise, an important part is played by the just limited time generally available during a sales discussion. Within this time it is necessary for the salesperson to present the advantages of his goods or service to the customer in as transparent a manner as possible and, at the same time, to prepare a solution that is, as far as possible, optimal for the customer.

In respect of the drawing up, during the customer discussion, of a solution that is best matched to the customer, it should finally be pointed out that this customer-specific solution frequently cannot be drawn up until during the customer discussion because the actual requirements of the customer generally do not become apparent to the salesperson until during the course of the customer discussion.

It is true that, for such customer discussions, laptop computers are also already being used occasionally in order to simplify the drawing up of a customer-specific solution during the customer discussion. However, it is not possible, using laptop computers, to present to the (potential) customer clearly, in a “manner that is pleasant” for the customer, the advantages and scope of the service or goods offered by the salesperson. This is due to the fact that any laptop computer is in the form of a “one-man work station” and therefore is suitable to an only limited extent, if at all, as a presentation aid in a customer discussion. In particular, a laptop computer used as a presentation aid prevents almost all eye contact between the salesperson and the (potential) customer. This results in the fact that, when using a laptop computer as a presentation aid in a customer discussion, the direct contact between the salesperson and the potential customer is lost or cannot even be established in the first place. This set of problems has been known for a long time. For this reason, it has not hitherto been possible for use of a laptop computer as a presentation system to become established practice in customer discussions.

Starting from the above-described requirements for a customer discussion that is, as far as possible, optimal, the present invention is based on the problem of providing a presentation system for use as an electronic selling aid of the kind mentioned at the beginning, by means of which, in a “manner that is pleasant” for the customer, it is possible, on the one hand, in as efficient a manner as possible, to impart to the client or customer, in a short time, an overview of the advantageousness and usefulness of the offered services or goods for his enterprise and, on the other hand, to draw up during the customer discussion, in transparent manner, a solution that is optimally matched to the customer and to explain it to the customer during the customer discussion itself. The presentation system should furthermore be usable in especially flexible manner.

The problem is solved, in accordance with the invention, by a presentation system which has the following:
an operating module having an associated operating module monitor for showing first information content, especially for showing information intended for a salesperson, and for showing data for controlling the course of a presentation shown on a base module monitor;
an inputting interface electronically and/or electrically coupled to the operating module, by means of which data is inputtable, especially in dependence on the information content shown on the operating module monitor;
electrically connected or connectible to the operating module, a base module having the base module monitor for showing second information content such as, for example, a presentation intended for a customer;
a control module which is arranged to individually control each of the operating module monitor and the base module monitor in dependence on a presentation loaded on the presentation system and/or the data input by way of the inputting interface; and
a cover which is tiltable relative to the base module about a first axis of rotation and connected to the base module, and which so co-operates with the base module that the presentation system can be changed from a first state, in which the inside of the main surface of the cover lies at least partly on the base module monitor, into a second state, in which the cover is tilted about the first axis of rotation relative to the base module and the base module monitor is facing in a first direction, and into a third state, in which the base module monitor is facing in a second direction which is opposite to the first direction.

The advantages obtainable with the solution according to the invention—especially when used as an electronic selling aid for advertisements in print media etc.—are very clear. On the one hand, the proposed solution provides a presentation system which makes it possible, by virtue of its construction as an electronic system, to dispense with all hand-outs, information sheets etc.. On the other hand, the solution according to the invention makes it possible for the customer data updated during a customer discussion to be input directly into the presentation system by way of the inputting interface and for it to be included in the presentation to be shown to the customer during the customer discussion. This updated customer data is accordingly included in the presentation or the course of the presentation, which substantially simplifies the possible subsequent further processing of that data.

The presentation system especially has a control module, by means of which a presentation is played on the base module monitor, the control module preferably being arranged to generate individualised solutions or parts thereof during the customer discussion and to present them, at least in part, to the customer.

In particular, arrangements are made in accordance with the invention for the base module monitor, which is arranged to show the customer the sales presentation, to be integrated in the base module, whilst the operating module monitor having the inputting interface is contained in the operating module. Because the salesperson usually sits opposite the customer in a customer discussion, it is possible, with the arrangement of the presentation system according to the invention, for the presentation system to be so constructed that the base module having the base module monitor is in front of the customer while the operating module having the operating module monitor and the inputting interface is in front of the salesperson. This ensures that the sales presentation can be made in a manner that is pleasant for the customer whilst the customer can optimally view the base module monitor.

The operating module monitor, which is integrated in the operating module, which faces the salesperson during the sales discussion, serves for showing information intended for the salesperson, especially customer-specific data, and data for controlling the course of the presentation shown on the base module monitor. Accordingly, the displays shown on the two monitors of the presentation system are usually different from one another. Especially as a result of the fact that, on the one hand, the data and information that is relevant for the salesperson is displayed on the operating module monitor, whereas, on the other hand, the presentation intended for the customer, that is to say the data and information that is relevant for the customer, is shown on the base module monitor, it is possible for the presentation to be made very clear for the (potential) customer. The displays on the respective monitors are, especially, independent of one another. It is accordingly ensured that, during the sales discussion, the (potential) customer is confronted only with that data and information which is actually intended for him. As a result, especially, overwhelming the customer with data and information that is not relevant to him is avoided.

On the other hand, the presentation system and, in particular, the control module provided in the presentation system should be arranged to individually control the base module monitor and the operating module monitor of the presentation system in dependence on a presentation loaded on the presentation system and/or on commands and/or data input by way of the inputting interface. This feature makes it possible for a customer-optimised presentation to be playable on the presentation system. For example, it is feasible for the presentation shown on the presentation system to be used as an aid for the selling of advertisements. The latter usually have a very particular geometric shape, which is individually filled with textual content. Relevant data in regard of a target person, that is to say information compiled for a very specific contact person at a potential customers, can then be input by the salesperson by way of the inputting interface of the control module during the sales discussion.

The presentation system furthermore has a cover which is tiltable relative to the base module about a first axis of rotation and connected to the base module. The cover allows the user to put the presentation system into three states which are different from one another, in order, by appropriate orientation, to adapt the presentation system by simple means to different areas of use and situations in the customer discussion. When the presentation system is in a first state, the inside of the main surface of the cover lies on the base module monitor. Accordingly, the display of the base module monitor can, by simple means, be protected from damaging external influences such as, for example, excessive solar radiation or moisture or also, however, objects which come into contact with the display and, as a result, would possibly scratch it or even cause it to break.

As a result of appropriate tilting of the cover about a predetermined or predeterminable angle relative to the base module, the presentation system can be changed from a first state into a second state, in which one edge of both the cover and the base module lie on a support surface, for example a table etc.. In that state, the lateral surfaces of the cover are oriented substantially vertically relative to the support surface. When the presentation system is in that second state, the cover performs a supporting function for the base module. By this means, the presentation system is simple to orient to the particular preferred viewing and sitting direction of the user so that he can view the presentation content shown on the base module monitor of the base module in an, as far as possible, optimal and pleasant manner.

In order that the supporting function of the cover is maintained even in the event of minor jolts and movements, for example against the support surface formed by a table on which the presentation system is placed, one side of the main surface of the tilted cover lies at least partly against a portion of area of the underside of the base module. This contact between the two surfaces can, for example, be accomplished advantageously by means of a shape-based connection. In a preferred embodiment provision is made, for example, for a portion of the underside of the base module to be, for example, in the form of a wedge-shaped recess, in the area of which an edge or the inside of the main surface of the cover lies on or in. The shape of the recess therein can take any form and is not limited to the above-described arrangement. It would of course likewise be feasible for the inside of the main surface of the cover to have a corresponding shape formation so that as a result complementary engagement of a surface or edge of the cover with the underside of the base module occurs. By that means it can be ensured that the supporting function of the cover, for example in the case of directly occurring jolts or sudden movements against the presentation system and/or its support surface, is maintained and the presentation system is prevented from toppling over.

When the presentation system is in the second state, the base module monitor faces in a first direction so that the salesperson can use the display of the base module monitor in order, for example, before a customer discussion to check the course of the presentations intended for the customer beforehand in respect of the way in which they are shown. In this so-called laptop mode, in which the user directly views the base module monitor set up in front of him and the operating module of the user is positioned in front of the base module monitor, the user can at the same time modify the presentation content shown on the base module monitor by inputting data by way of the operating module.

In a further advantageous embodiment, it is furthermore possible to change the presentation system from a first or second state to a third state, in which the base module monitor is facing in a second direction which is opposite to the first direction. This so-called “presentation mode” is suitable preferably for situations in customer discussions. In this context, the salesperson and the (potential) customer sit opposite one another. The salesperson, by way of the operating module located in front of him, controls the presentation content which is displayed on the base module monitor to the (potential) customer sitting opposite him. In that state, the underside of the inclined base module lies at least partly on the inside of the main surface of the cover. The lateral surfaces of the cover, which in this third state are oriented substantially horizontally, lie at least partly on the support surface and in so doing ensure the necessary stability for the presentation system oriented in this manner.

When the presentation system is in this third state, the position of the base module monitor is accordingly so adjusted in advantageous manner that during a customer discussion the customer views the base module monitor located in front of him in an, as far as possible, optimal manner and nevertheless retains eye contact with the salesperson sitting opposite him. Of course the presentation system can at any time be changed back from its third state to a second or first state as desired, by appropriately tilting the cover relative to the base module.

As already indicated, the presentation running on the presentation system according to the invention preferably comprises software which describes a method of generating an individualised customer proposal. In this method, preferably, the customer-relevant data input during the sales discussion by way of the inputting interface is analysed preferably using machine learning. The expression “machine learning” is to be understood herein as especially a self-optimisation process which, on the basis of automatic changes in evaluation criteria etc., produces an improved result on each new run-through. The result is all the better if a greater probability of closing a deal in advertisement selling is achieved.

The advantage of the presentation system according to the invention accordingly lies in the fact that, during the sales discussion, a large amount of individualised customer data can be collected and input into the control module by the salesperson by way of the inputting interface of the presentation system, with evaluation of that individualised customer data being carried out with the aid of the presentation software running on the presentation system so that for different (potential) customers, in real time, that is to say during the sales discussion, an individualised proposal can be produced, incorporated into the presentation that is to be shown to the customer, and shown on the base module monitor of the presentation system.

It is, especially, feasible that, during assessment of the individualised customer data input by way of the inputting interface of the presentation system, inter alia, a number of prototype classes of so-called customer models are also formed, these customer models representing idealised customer types which have emerged in the classical sales process. The advantage of prototype classes formed using a classifying algorithm lies in the fact that a large number of individualised customers can be mapped onto these prototype customer classes so that although further processing of the information on an individual basis with respect to an individual customer is possible it is still possible to carry out abstract further processing on the basis of the properties of the classes. More abstract further processing in this context means that a whole group of customers can be treated in the same way, for example by means of identical control parameters being input in the next step of the method. This can mean, inter alia, the use of identical customer solutions drawn up during the customer discussion. In the process, the advantages both of purely individualised treatment and also of purely class-based treatment of customer groups are combined with one another.

Preferably, the information content presented to the customer on the base module monitor consists not of a sequence of standard presentation pages but rather of a tailored sequence of presentation pages which are so arranged that they guide the customer through the sales discussion in structured manner. In the process, information that is directed only to the salesperson is shown on the operating module monitor in such a way that only he can read it, because it will be seen, for example, by the discussion counterpart (customer) as being “upside-down”, whereas the information that is relevant for the customer will be shown on the base module monitor of the presentation system so that it can be easily read by the potential customer and—when the customer and salesperson are sitting directly opposite one another in the customer discussion—will be seen by the salesperson as being “upside-down”.

Preferably, the data shown on the operating module monitor of the presentation system and serving for controlling the course of the presentation shown on the base module monitor comprises a sequence of presentation pages which can be selected by the salesperson during the sales discussion and displayed on the first monitor.

In a preferred arrangement of the presentation system according to the invention, a slide-in compartment is formed in the base module, which serves to accommodate the operating module together with the associated operating module monitor. In this context, the operating module together with the associated operating module monitor should be in the form of a unit which can be slid into the slide-in compartment of the base module. Preference is further given to the operating module together with the associated operating module monitor being slidable in and out from a first position, in which the operating module together with the associated operating module monitor has been pulled out from the slide-in compartment to in front of the base module, to a second position, in which the operating module together with the associated operating module monitor has been slid into the slide-in compartment of the base module.

In a preferred development of the last-mentioned embodiment of the presentation system, provision is further made for the operating module together with the associated operating module monitor to be tiltable in the first position relative to the base module about a second axis of rotation.

On the other hand, it would also be feasible for the operating module together with the associated operating module monitor to be connected to the base module by way of a hinge connection and to be arranged to be foldable in and out by means of the hinge connection from a first position, in which the operating module together with the associated operating module monitor is, after being pulled out from the slide-in compartment of the base module in the longitudinal direction, folded out in front of the base module, into a second position, in which the operating module together with the associated operating module monitor is folded into the base module. Furthermore, the operating module is arranged to be pivotable about the second axis of rotation when the operating module is in the first position. In this advantageous manner, the orientation of the operating module is very simply adaptable to the state, that is to say the particular selected orientation, of the presentation system

If the customer and the salesperson are sitting opposite one another in the sales discussion it is desirable for the clear view between the salesperson and the customer not to be impeded. For this reason, in the presentation system according to the invention, the operating module and the base module are rotated through 180° relative to one another. Accordingly, the operating module and the base module can be so arranged for the customer discussion that no vertically, or almost vertically, extending display device etc. stands between the customer and the salesperson and accordingly impedes the clear view. In an especially preferred arrangement of the presentation system provision is preferably made for the control module provided in the presentation system to automatically adjust the orientation of the presentation shown on the base module monitor in dependence on the arrangement of the operating module and the base module relative to one another.

By means of this preferred development of the presentation system according to the invention it is accordingly possible, on the one hand, to operate the presentation system in a third state, the “presentation mode”, in which the salesperson sits opposite the (potential) customer and the base module monitor of the presentation system is oriented towards the customer whilst the information and data displayed on the operating module monitor is oriented towards the salesperson. In this mode, the presentation shown on the base module monitor is then oriented in a direction opposite to the orientation of the information and data shown on the operating module monitor. On the other hand, in a second state of the presentation system, the “laptop mode”, preference is given to the presentation shown on the base module monitor being oriented in the same direction as the information and data shown on the operating module monitor. The presentation system can then be used also for customer discussions in which the customer and salesperson are not sitting opposite one another but rather, for example, are standing next to one another in front of the presentation system.

In order to ensure that the control module of the presentation system “automatically” sets the correct orientation of the presentation to be displayed on the base module monitor, it is—if the operating module is tiltably connected to the base module by way of a hinge connection—feasible, for example, to integrate an appropriate sensor in the hinge connecting the operating module and the base module, which sensor registers the degree of folding-out of the operating module and delivers corresponding signals to the control module in dependence on the angle of folding-out of the operating module. However, it would be likewise feasible for the base module to be provided with a corresponding sensor device which performs the above-described function of automatically adapting to the “correct” orientation.

As already explained, preference is given to presentation software, which can be influenced by the commands and/or data input from the inputting interface, running on the presentation system according to the invention. In a preferred arrangement of this embodiment, the control module has, for the purpose, a storage means for storing data for customer-specific presentations and for storing data input by way of the inputting interface, and also a processor for processing data input by way of the inputting interface and for modifying the presentation to be shown on the base module monitor in dependence on data or commands input by way of the inputting interface.

It is, in principle, advantageous, if the control module of the presentation system according to the invention further has a preferably wireless communications interface, especially a mobile telephone interface, IR interface or Bluetooth interface, in order to make data communications possible with external devices. Of course, however, the communications interface can also be wired, such as, for example, an interface for a PDA device, or an interface for a USB stick. By means of this additional communications interface it is possible to transfer into the control module the presentation to be shown using the presentation system. On the other hand, an interface of such a kind for an external device is also suitable for the purpose of downloading from the presentation system, after the sales discussion, the solution specifically drawn up for the customer in order to be able to further process it or to store it externally.

In an especially preferred embodiment of the presentation system according to the invention, the operating module monitor, on which there is shown the information intended for the salesperson and also the data for controlling the course of the presentation shown on the base module monitor, is in the form of a touch screen monitor, with the inputting interface of the presentation system being integrated, in the form of a touch screen field, in this operating module monitor in the form of a touch screen monitor. In this case it would furthermore be feasible for the presentation system to be provided with the functionality of text recognition so that the inputting of information can be carried out with the aid of a touch screen stylus pen by way of the inputting interface. Of course, however, it is also feasible for the base module monitor serving for showing the presentation intended for the customer to be in the form of a touch screen monitor.

In order to ensure that, during a sales discussion, the (potential) customer can watch the sales presentation shown on the base module monitor with optimum image quality independently of the viewing location, preference is given to at least the base module monitor being in the form of a display screen without a particular preferential viewing direction. This preferred development accordingly prevents colour distortions etc. coming about in dependence on the location of the viewer (customer). In particular, brightness, colour and contrast exhibit changes if a screen without a particular preferential viewing direction is not used as the base module monitor and the predetermined viewing angle is not maintained. Accordingly, preference is given to using, as the base module monitor, a screen based on plasma technology or an LC display of class I (according to ISO standard 13406-2). Of course, however, other screens which do not have a particular preferential viewing direction also come into consideration.

In order to simplify the inputting of data by way of the inputting interface of the presentation system, especially when the data comprises lengthy text fields etc., provision can preferably be made for the inputting interface to additionally have a keyboard connected or connectible to the control module. By means of this development the functionality of the presentation system is correspondingly extended so that—for example, after a customer discussion—it can also be used as a kind of laptop computer.

In order to allow operational redundancy of the presentation system, the latter should further have an internal power supply, for example in the form of preferably rechargeable batteries and/or a fuel cell. When rechargeable batteries are used as an internal power supply, it is accordingly feasible in a preferred arrangement of the presentation system for the mains unit or charging device required for charging those rechargeable batteries to be provided externally to the presentation system in order, on the one hand, to prevent heat being unnecessarily generated in the interior of the presentation system during the charging period and, on the other hand, to ensure that the overall size of the presentation system is as small as possible. In this context special preference is given to the rechargeable batteries being chargeable by means of, for example, a car battery in order to meet requirements in field sales.

Preferred embodiments of the presentation system according to the invention are described hereinbelow with reference to the accompanying drawings, in which:

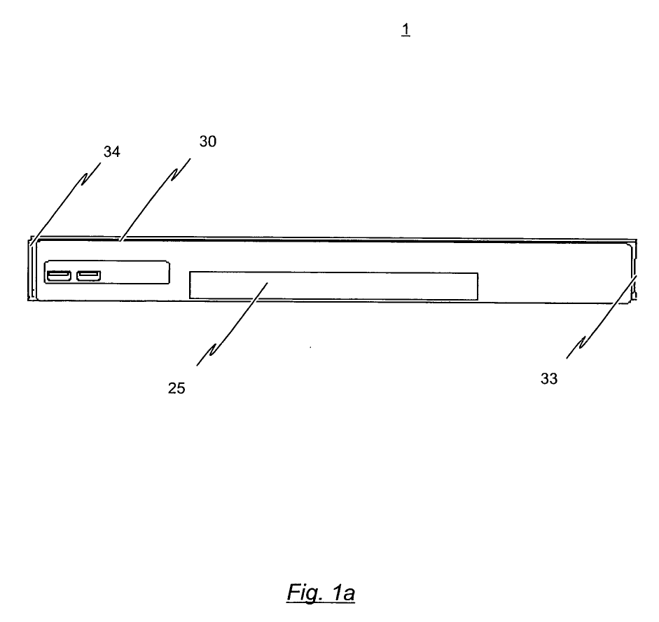

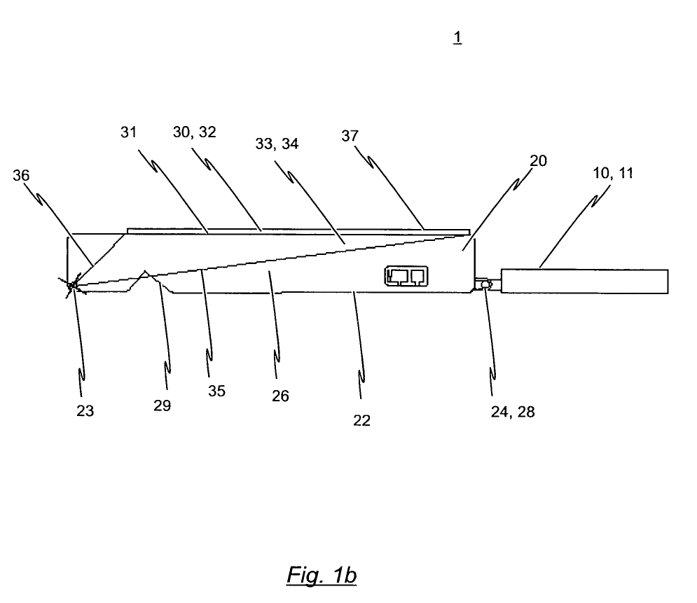

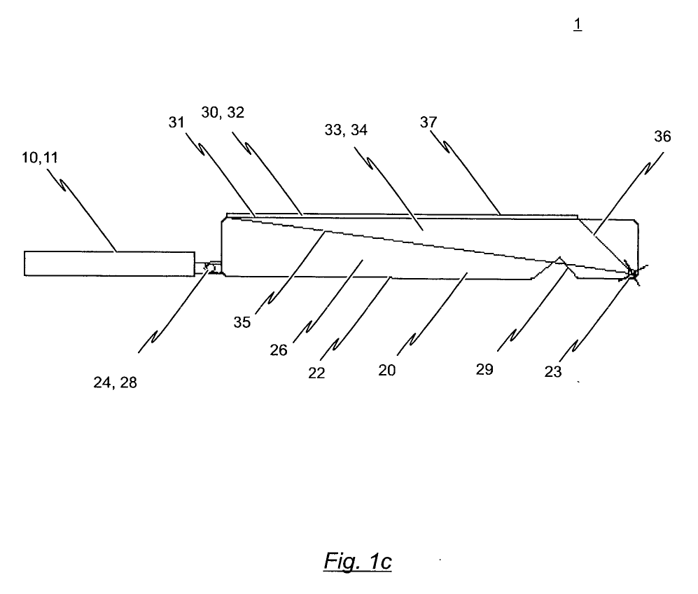

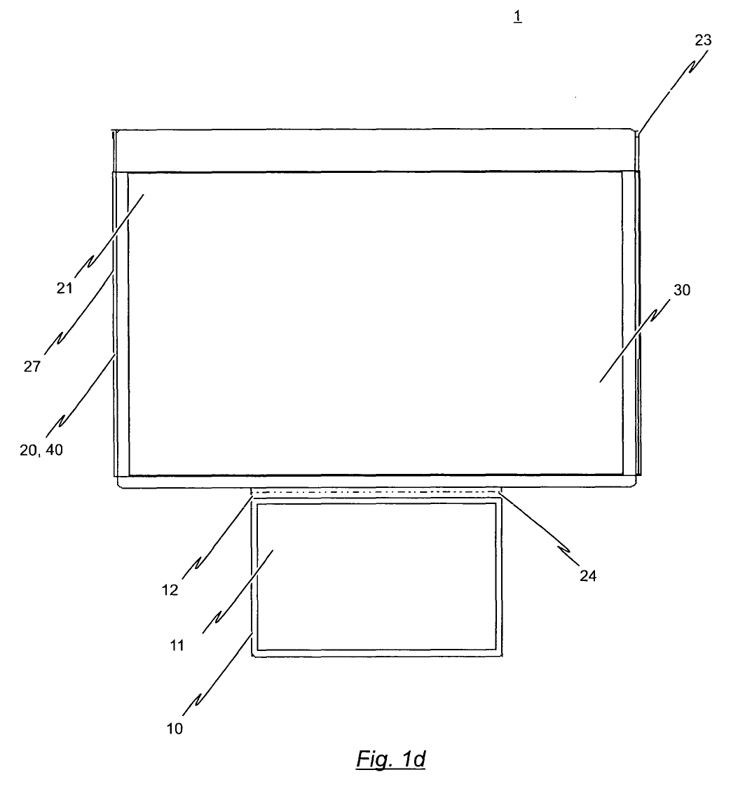

FIGS. 1a-d are a front view, two side views and a top view of a first embodiment of the presentation system according to the invention occupying its first state;

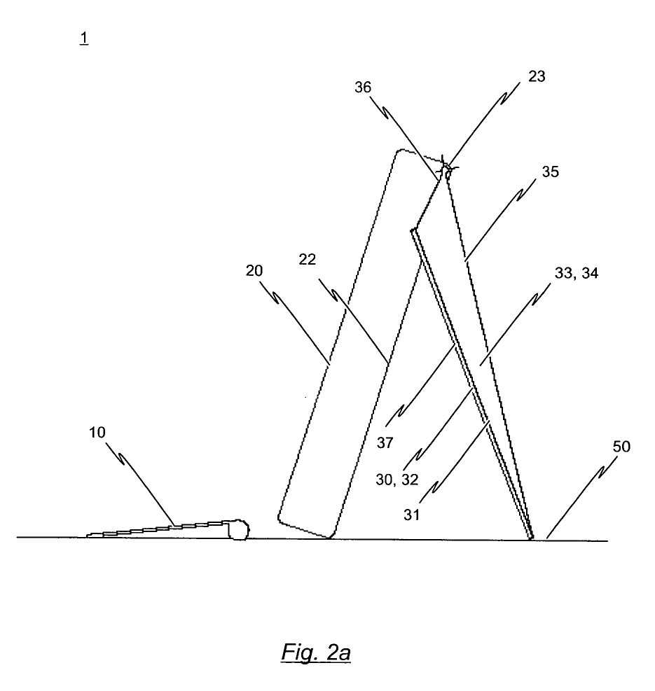

FIG. 2a is a side view of the presentation system according to a second embodiment of the invention occupying its second state;

FIG. 2b is a side view of the presentation system according to the first embodiment of the invention occupying its second state;

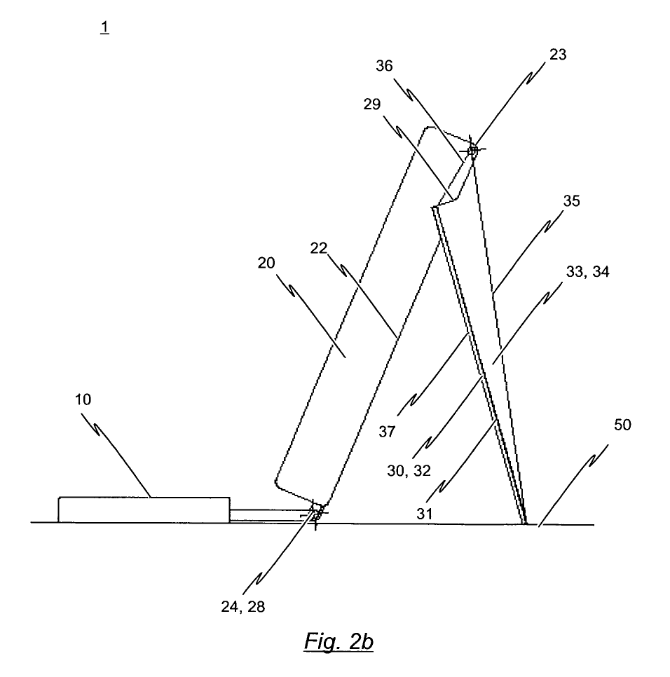

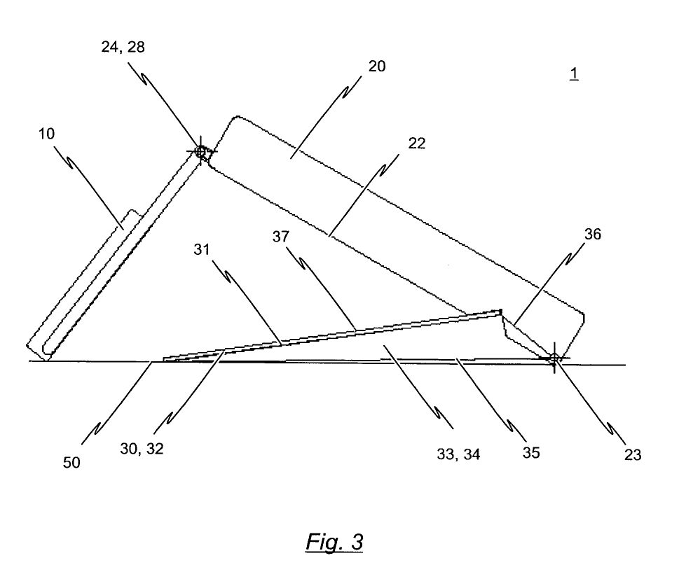

FIG. 3 is a side view of the presentation system according to the first embodiment of the invention occupying its third state.

There will be described hereinbelow with reference to FIGS. 1a to 1d a first embodiment of the presentation system 1 according to the invention occupying its first state. In this context there are shown in FIGS. 1a to 1d a front view, two side views that are different from one another, and a top view of the presentation system 1, with the presentation system 1 occupying its first state in these illustrations, in which the operating module 10 and the base module 20 connected to that operating module 10 are lying flat next to one another on a support surface (not explicitly shown).

As shown in FIGS. 1a to 1d, the presentation system 1 according to the first preferred embodiment basically has the following components: the already mentioned operating module 10, in which an operating module monitor 11 is integrated; an inputting interface 12 electronically coupled to the operating module 10; a base module 20 which is electrically connected to the operating module 10 and in which a base module monitor 21 is integrated; and a control module (not explicitly shown) which in the first preferred embodiment of the present invention is integrated in the base module 20. The operating module monitor 11 of the operating module 10 serves for showing first information content, especially for showing information intended for a salesperson, and for showing data for controlling the course of a presentation shown on the base module monitor 21. By way of the inputting interface 12, which is electronically coupled to the operating module 10, it is possible to input data (commands, information etc.) in dependence on the information content shown on the operating module monitor 11. The base module monitor 21, which is integrated in the base module 20, serves for showing second information content such as, for example, a presentation intended for a customer. The control module 40 integrated in the base module 20 is arranged to individually control each of the operating module monitor 11 and the base module monitor 21 in dependence on a presentation loaded on the presentation system 1 and/or in dependence on data input by way of the inputting interface 12.

As is furthermore shown in the illustrations of FIGS. 1a to 1d, the shown embodiment of the presentation system 1 according to the invention has a cover 30, which is connected to the base module 20 so as to be tiltable relative to the base module 20 about a first axis of rotation 23. When the presentation system 1 of the shown first embodiment is in this first state, the inside 31 of the main surface 32 of the cover 30 lies on the base module monitor 21. In the shown embodiment of FIGS. 1a to 1d, each of the lateral surfaces 33 and 34 of the cover, which are connected to the main surface 32 of the cover, lie parallel against a lateral wall 26 of the base module 20. By this means, the cover 30 can protect the base module together with the base module monitor 21 from external and damaging influences such as, for example, strong solar radiation or moisture.

From the illustration of FIGS. 1b and 1c it can furthermore be seen that the base module 20 has, on its underside 22, a recess 29. This recess 29 serves as a support surface for the tiltable cover 30 in order, in a second state of the presentation system 1, to appropriately stand the base module 20 up on a support surface 50 on which the presentation system 1 is placed. In this context, the shape of the recess 29, as shown in the embodiment of the illustration in FIGS. 1b and 1c, is not limited to the wedge-shaped structural form shown but rather can be constructed with any advantageous shape which is suitable for resting the cover 30 on it or against it in order to support the base module 20. Nor must it necessarily be a recess. It would also be feasible for the underside 22 of the base module 20 to have a sub-part which is foldable in and out and projects from the underside 22 of the base module 20 and against which the cover 30 can be placed.

The embodiments, shown in FIGS. 1 to 3, of the presentation system 1 according to the invention are also especially distinguished by the fact that a slide-in compartment 25 is constructed in the base module 20, which compartment serves to accommodate, when required, the operating module 10 together with the associated operating module monitor 11. In this arrangement, the operating module 10 together with the associated operating module monitor 11 is in the form of a unit which can be slid into the slide-in compartment 25 of the base module 20 and is arranged to be slidable in and out from a first position, in which the operating module 10 together with the associated operating module monitor 11 has been pulled out from the slide-in compartment 25 to in front of the base module 20, into a second position, in which the operating module 10 together with the associated operating module monitor 11 has been slid into the slide-in compartment 25 of the base module 20. The illustrations in FIGS. 1a to 1d, 2b and 3 each show the operating module 10 in its first position, in which the operating module 10 together with the associated operating module monitor 21 has been pulled out in the longitudinal direction from the slide-in compartment 25 of the base module 20.

It can be seen especially from the illustrations in FIGS. 2b and 3 that the operating module 10 together with the integrated operating module monitor 11 is, in its first position, tiltable relative to the base module 20 about a second axis of rotation 24. For this purpose, a suitable hinge connection 28 is provided at the edge between the operating module 10 and the base module 20. Of course, however, it would also be feasible, instead of providing a slide-in compartment 25, for the operating module 10 together with the integrated operating module monitor 11 to be connected to the base module 20 by way of a separate hinge connection and to be arranged to be foldable in and out by means of this separate hinge connection from a first position, in which the operating module 10 together with the associated operating module monitor 11 has been folded out in front of the base module 20, into a second position, in which the operating module 10 together with the associated operating module monitor 11 has been folded into the base module 20.

In the illustrations of FIGS. 1a to 1d, 2b and 3, the operating module 10 is, in this first embodiment of the presentation system 1 according to the invention, connected by means of a suitable hinge connection 28. This is, however, not absolutely necessary. It would especially also be feasible, for example, for the operating module 10 to be constructed so that it is independent and separate from the base module 20, in which case these two modules can communicate with one another by way of a cable-free communications interface such as, for example, a mobile telephone interface, IR interface or Bluetooth interface.

The illustrations of FIGS. 2a and 2b show the presentation system 1 according to the invention in a second state. In that state, the cover 30 is so tilted relative to the base module 20 about a first axis of rotation 23 through a predetermined or predeterminable defined angle that one edge of both the cover 30 and the base module 20 lie on a support surface 50. The two lateral surfaces 33, 34 of the cover 30 are then oriented substantially vertically relative to the support surface 50.

In order to provide the stood-up base module 20 in FIGS. 2a and 2b with the requisite stability, at least a portion of the outside 37 of the main surface 32 of the tilted cover 30 lies against the underside 22 of the base module 20 in such a way that the outside 37 is connected to a surface of the recess 29. By this means, the cover 30 contributes to the base module 20, in the second state of the presentation system 1, standing up at a defined angle of inclination relative to the support surface 50. The complementary lying against one another of the surfaces of the cover 30 and of the base module 20 is not limited to the arrangements shown in FIGS. 2 to 3. It would likewise be feasible, for example, for the main surface 32 of the cover 30 to have an appropriate recess or raised portion in order to provide the cover 30 with a supporting function for the base module 20 leant against it.

When the presentation system 1 is in the second state, and as shown in FIGS. 2a and 2b, the base module monitor 21 in the so-called laptop mode faces in a direction that is opposite to that in a third state of the presentation system 1, as can be seen from the illustration of FIG. 3. When the presentation system 1 is in the second state, the operating module 10 is located in front of the base module monitor 21 so that the salesperson has a direct view of the base module monitor 21 and can simultaneously see on the base module monitor 21 the data he has input by way of the operating module 10. The orientation of the information content shown on the two monitors 11 and 21 is therefore identical when the presentation system 1 is in the second state.

The third state of the presentation system 1 according to the invention can be seen from the illustration of FIG. 3. In that state, the base module monitor 21 faces in a second direction, which is opposite to the first direction, when the presentation system 1 is in its second state. The third state, which is referred to herein as the so-called “presentation mode”, makes it possible for the presentation system 1 to be so oriented that the salesperson and the (potential) customer can sit opposite one another. The salesperson then has the operating module 10 together with his operating module monitor 11 located in front of him and uses it to control the presentation content displayed on the base module monitor 21 of the base module 20 to the customer sitting opposite. In this third state, the customer is shown on the base module monitor 21 only that presentation content which is intended for him and is not distracted by control of the presentation, which belongs to the salesperson's remit.

As can be seen from the illustration of FIG. 3, the third state of the presentation system 1 is achieved by means of the underside 22 of the base module 20 lying at least in part on the outside 37 of the main surface 32 of the cover 30. In this third state, the cover 30 supports the base module 20 in such a way that the base module monitor 21 is inclined at a defined angle to the viewing direction of the customer. For orientation of the base module monitor 21 relative to a support surface 50, at least one outside edge 35 of the lateral surfaces 33, 34 of the cover 30 is then set down substantially horizontally and at least partly on the support surface 50. In this third state, the supporting effect of the cover 30 is especially also achieved by the underside 22 of the base module 20 lying at least partly on the outside 37 of the main surface 32 of the cover 30. In the arrangement of the illustration of FIG. 3 it can also be seen that, by virtue of the recess 29 on the underside 22 of the base module, engagement with the outside 37 of the main surface 32 of the cover 30 is achieved as a result of a surface of the recess 29 of the base module 20 being in complementary connection with the main surface 32 of the cover 30.

It should be mentioned at this juncture that the presentation system 1 can be changed from both the first state and the second state into the third state. Of course return from the third state to the first or second state is likewise possible at any time.

The presentation system 1 is preferably arranged to automatically select the orientation of the respective images on the operating module monitor 11 and the base module monitor 21 in dependence on the state occupied by the presentation system 1. In particular, the images on these two monitors 11 and 21 should have opposite orientations in the third state (compare FIG. 3). In a preferred arrangement, it is feasible for appropriate sensors to be arranged, for example, at the hinge connection 28 or provided directly in the base module 20, by means of which the particular state of the presentation module 1 is registered and the orientation of the images on the monitors 11, 21 adapted accordingly.

As already mentioned, the presentation system 1 according to a first embodiment has the operating module 10 having, integrated therein, the operating module monitor 11. The operating module 10 is then further provided with an inputting interface 12, which in the shown embodiment is in the form of respective touch screen operating fields which are integrated in the operating module monitor 11.

In the presentation system 1 according to the first embodiment, the control module 40 is integrated in the operating module 10. The base module 20 together with the base module monitor 21 is in tiltable articulated connection with the operating module 10 by way of the hinge connection 28.

Special preference is given to at least the operating module monitor 11 being in the form of a touch screen monitor so that it is possible, by means of suitable touch screen fields, to input commands and data into the presentation system 1, especially for controlling the course of the presentation shown on the base module monitor 21. Accordingly, in the presentation system 1 shown in the drawings, the touch screen fields of the operating module monitor 11 serve as the inputting interface 12 for the presentation system 1.

In addition to these inputting interfaces 12, it is furthermore feasible for the presentation system 1 to have an additional keyboard connectible to the presentation system 1, as shown, for example, in the illustration of FIG. 2a.

Although it cannot be seen explicitly from the drawings shown, the control module 40 further includes, preferably, a storage means for storing presentations which are to be displayed on the base module monitor 21. The storage means preferably serves also for storing data which is or has been input into the presentation system 1 by way of the inputting interface 12. In addition thereto, preference is given to the control module 40 further having a processor in order to be able to process the data input by way of the inputting interface 12 and in order to modify the presentation to be shown on the base module monitor 21 in dependence on, for example, data or commands input by way of the inputting interface 12, preferably during a sales discussion.

The control module 40 should further have a preferably wireless communications interface such as, for example, a mobile telephone interface, IR interface or Bluetooth interface in order to make data communications possible with external devices.

### List of Reference Numerals

1. presentation system

10. operating module

11. operating module monitor

12. inputting interface

20. base module

21. base module monitor

22. underside of base module

23. first axis of rotation

24. second axis of rotation

25. slide-in compartment

26. lateral wall of base module

27. sensor device

28. hinge connection

29. recess in cover

30. cover

31. inside of main surface

32. main surface of cover

33, 34. lateral surfaces of cover

35. outside edge of lateral surface

36. inside edge of lateral surface

37. outside of main surface of cover

40. control module

50. support surface

What is claimed is:

1. Presentation system (1), especially for use as an electronic selling aid for advertisements, for example in print media, on the internet or the like, the presentation system (1) having the following:
an operating module (10) having an associated operating module monitor (11) for showing first information content, especially for showing information intended for a salesperson, and for showing data for controlling the course of a presentation shown on a base module monitor (21);
an inputting interface (12) electronically and/or electrically coupled to the operating module (10), by means of which data is inputtable, especially in dependence on the information content shown on the operating module monitor (11);
electrically connected or connectible to the operating module (10), a base module (20) having the base module monitor (21) for showing second information content such as, for example, a presentation intended for a customer;
a control module (40) which is arranged to individually control each of the operating module monitor (11) and the base module monitor (21) in dependence on a presentation loaded on the presentation system (1) and/or the data input by way of the inputting interface (12); and
a cover (30) which is tiltable relative to the base module (20) about a first axis of rotation (23) and connected to the base module (20), and which so co-operates with the base module (20) that the presentation system (1) can be changed from a first state, in which the inside (31) of the main surface (32) of the cover (30) lies at least partly on the base module monitor (21), into a second state, in which the cover (30) is tilted about the first axis of rotation (23) relative to the base module (20) and the base module monitor (21) is facing in a first direction, and into a third state, in which the base module monitor (21) is facing in a second direction which is opposite to the first direction.

2. Presentation system (1) according to claim 1, wherein, when the presentation system (1) is in the second state, the cover (30) is so tilted relative to the base module (20) through a predetermined or predeterminable defined angle that one edge of both the cover (30) and the base module (20) lie on a support surface (50);
and wherein the cover (30) is provided with lateral surfaces (33, 34), which are oriented substantially vertically relative to the support surface (50), the outside (37) of the main surface (32) of the cover (30) lying against the underside (22) of the base module (20); and
wherein, when the presentation system (1) is in the third state, the underside (22) of the base module (20) lies at least partly on the outside (37) of the main surface (32) of the cover (30) and at least one outside edge (35) of the lateral surfaces (33, 34) of the cover (30) lies substantially horizontally and at least partly on the support surface (50) so that the base module monitor (21) faces in a second direction.

3. Presentation system (1) according to claim 1, wherein a slide-in compartment (25) is formed in the base module (20) for accommodating the operating module (10) together with the associated operating module monitor (11), and wherein the operating module (10) together with the associated operating module monitor (11) is in the form of a unit which can be slid into the slide-in compartment (25) of the base module (20) and is arranged to be slidable in and out from a first position, in which the operating module (10) together with the associated operating module monitor (11) has been pulled out from the slide-in compartment (25) to in front of the base module (20), to a second position, in which the operating module (10) together with the associated operating module monitor (11) has been slid into the slide-in compartment (25) of the base module (20).

4. Presentation system (1) according to claim 3, wherein, in the first position, the operating module (10) together with the associated operating module monitor (11) is tiltable relative to the base module (20) about a second axis of rotation (24).

5. Presentation system (1) according to claim 3, wherein the operating module (10) together with the associated operating module monitor (11) is, in one state of the presentation system (1), arranged to be brought into the first position, the operating module (10) being arranged to be pulled out from the slide-in compartment (25) of the base module (20) in the longitudinal direction, and furthermore the operating module (10) being pivotable about the second axis of rotation (24).

6. Presentation system (1) according to claim 1, wherein, when the presentation system (1) is in the second state, the image on the base module monitor (21) and the image on the operating module monitor (11) have the same orientation, and wherein, when the presentation system (1) is in the third state, the image on the base module monitor (21) and the image on the operating module monitor (11) are differently oriented by 180°.

7. Presentation system (1) according to claim 1, wherein the base module (20) has a sensor device (27) which is arranged to adapt the orientation of the information displayed on the base module monitor (21) of the base module (20) in dependence on the state occupied by the presentation system (1).

8. Presentation system (1) according to claim 1, wherein the control module (40) further has the following:
a storage means for storing presentations and data input by way of the inputting interface (12); and
a processor for processing data input by way of the inputting interface (12) and for modifying the presentation to be shown on the base module monitor (21) in dependence on data or commands input by way of the inputting interface (12).

9. Presentation system (1) according to claim 1, wherein the control module (40) further has, for data communications with external devices, a wireless communications interface, especially a mobile telephone interface, IR interface or Bluetooth interface.

10. Presentation system (1) according to claim 1, wherein the operating module monitor (11) is in the form of a touch screen, and wherein the inputting interface (12) is integrated, in the form of a touch screen field, in the operating module monitor (11) in the form of a touch screen.

11. Presentation system (1) according to claim 1, wherein the inputting interface (12) has a keyboard connected or connectible to the control module (40).

12. Presentation system (1) according to claim 1, which further has an internal power supply in the form of preferably rechargeable batteries and/or a fuel cell.

13. Presentation system (1) according to claim 2, wherein a slide-in compartment (25) is formed in the base module (20) for accommodating the operating module (10) together with the associated operating module monitor (11), and wherein the operating module (10) together with the associated operating module monitor (11) is in the form of a unit which can be slid into the slide-in compartment (25) of the base module (20) and is arranged to be slidable in and out from a first position, in which the operating module (10) together with the associated operating module monitor (11) has been pulled out from the slide-in compartment (25) to in front of the base module (20), to a second position, in which the operating module (10) together with the associated operating module monitor (11) has been slid into the slide-in compartment (25) of the base module (20).

14. Presentation system (1) according to claim 13, wherein the operating module (10) together with the associated operating module monitor (11) is, in one state of the presentation system (1), arranged to be brought into the first position, the operating module (10) being arranged to be pulled out from the slide-in compartment (25) of the base module (20) in the longitudinal direction, and furthermore the operating module (10) being pivotable about the second axis of rotation (24).

15. Presentation system (1) according to claim 13, wherein, in the first position, the operating module (10) together with the associated operating module monitor (11) is tiltable relative to the base module (20) about a second axis of rotation (24).

16. Presentation system (1) according to claim 15, wherein the operating module (10) together with the associated operating module monitor (11) is, in one state of the presentation system (1), arranged to be brought into the first position, the operating module (10) being arranged to be pulled out from the slide-in compartment (25) of the base module (20) in the longitudinal direction, and furthermore the operating module (10) being pivotable about the second axis of rotation (24).

17. Presentation system (1) according to claim 4, wherein the operating module (10) together with the associated operating module monitor (11) is, in one state of the presentation system (1), arranged to be brought into the first position, the operating module (10) being arranged to be pulled out from the slide-in compartment (25) of the base module (20) in the longitudinal direction, and furthermore the operating module (10) being pivotable about the second axis of rotation (24).
